(19) United States
(12) Patent Application Publication
(10) Pub. No.: US 2014/0129075 A1
(43) Pub. Date: May 8, 2014

(54) Vehicle Control Using Modeled Swarming Behavior

(71) Applicant: Dennis M. Carleton, Sewickley, PA (US)

(72) Inventor: Dennis M. Carleton, Sewickley, PA (US)

(21) Appl. No.: 13/668,535

(22) Filed: Nov. 5, 2012

(51) Int. Cl. G05D 1/00

(52) U.S. Cl. 701/27

(57) ABSTRACT

A system for controlling a group of vehicles as a whole in which each individual member of the group receives telemetry from other members of the group or from the group as a whole, and makes decisions regarding the setting and/or changing of local operating parameters based on the received telemetry.

### FIELD OF THE INVENTION

This invention is related to the field of robotics and, in particular, to the field of autonomous operation of vehicles or groups of vehicles.

### BACKGROUND OF THE INVENTION

It has long been a goal in the automotive industry to make operation of a motor vehicle easier for the driver. Most accidents involving motor vehicles are caused by driver error. Many variables affect the driver's ability to safely operate a motor vehicle, including, for example, experience and physical and mental condition. It is desirable, therefore, to move to a model wherein the operation of a motor vehicle is more autonomous, thereby relieving the driver of the tedious job of manually controlling the vehicle, which is tiresome and prone to user error.

Many steps have been taken in the direction of achieving fully autonomous operation of a motor vehicle as cars have evolved and become more technically advanced. One such innovation was the automatic speed control, commonly referred to as a “cruise control” which allows the operator to manually set a speed which is then maintained by the vehicle. The speed control can typically be disengaged by tapping on the brake. While most effective when used on a highway, the speed control feature has limitations. First, the speed control only controls the acceleration of the vehicle, not the braking. As such, it is known that when proceeding downhill, a vehicle's speed may increase over the speed set by the operator. In addition, the operator must be vigilant and disengage the cruise control when required due to traffic conditions (i.e., when encountering slower vehicles) or other road conditions. In addition, the speed control feature is not effective in urban driving situations which require frequent stops and starts and is dependant upon the current traffic situation and the moving of other vehicles.

However, recent improvements in the cruise control have been realized. In particular, it is now known in the art that a vehicle will be able to detect the current speed limit of the road on which it is driving and to adjust the speed setting of the cruise control in conformance therewith. It is possible to achieve this feature via using a GPS to detect position and a database which contains a road information to determine the speed limit at the vehicle's current location. Such a system is disclosed in U.S. Pat. No. 7,783,406 (2010, Rothschild).

Various other systems are also known to assist in the control of vehicle speed. For instance, it is known to have a feature installed on a vehicle which automatically applies the brakes in the event of an imminent collision. This is achieved via sensors, typically forward-facing or rearward-facing, which determine the proximity of the vehicle to other vehicles or other obstructions (including pedestrians) and which will apply the brake in the event that the driver fails to do so in a reasonable amount of time required for the vehicle to stop to avoid a collision.

More recent additions to autonomous vehicle operation include features which allow a vehicle to perform a parallel parking function free of driver intervention. Such systems require not only control of the speed of the vehicle but also control of the steering and braking apparatus of the vehicle.

It is also known in the art that a vehicle can have completely autonomous operation. For instance, Google, Inc. has recently demonstrated operation of a fully autonomous vehicle on the streets of major U.S. cities. However, while able to control its own operation, the autonomous vehicle is unable to influence or control the operation of other motor vehicles in close proximity thereto. As a result the autonomous vehicle is completely reactive to the actions of other motor vehicles, most of which are typically being manually controlled by human operators.

In addition to the foregoing it is also known in the art for vehicles to communicate with each other. This is advantageous in that communicating vehicles may convey positional information from one to the other to provide a collision avoidance function and in addition may transmit to each other information regarding road obstacles and traffic conditions. Exemplary systems for inter-vehicle communications are described in U.S. Pat. No. 7,532,130 (2009, Curtis), U.S. Pat. No. 7,593,999 (2009, Nathanson), U.S. Pat. No. 7,990,283 (2011 Breed) and U.S. Pat. No. 8,078,390 (2011, Manzel, et al.).

To provide completely autonomous operation of motor vehicles in both highway and urban traffic situations, it is necessary that the vehicles have influence on the operation and other vehicles, including both speed and direction. Therefore, it would be desirable to implement a system wherein communicating vehicles may convey information to each other and wherein such information may be used to control the operating parameters of a group of vehicles.

### SUMMARY OF THE INVENTION

The present application allows communicating vehicles to act in concert together in a manner very similar to a herd of animals. Swarm behavior can be seen not only in herds of animals but also in flocks of birds, swarms of insects and schools of fish wherein the group will act seemingly with one mind regarding both speed and heading. Such behavior can also be observed in humans, for example, during episodes of mob violence.

Swarming behavior is typically observed as collective behavior by a large number of self-propelled entities. When naturally occurring, such behavior is considered emergent, that is, arising from simple rules that are followed by individuals and not involving any central coordination. This emergent behavior can be mathematically modeled and has been simulated in software and also in micro-robots programmed to follow a simple set of rules.

In the animal world, it is thought that such behavior is reactive and occurs without communication between individuals other than the normal senses of the animal to detect movements of the other animals and to follow the example. In its simplest form, herding behavior could be implemented using three simple rules: (1) Move in the same direction as your neighbors, (2) Remain close to your neighbors and (3) Avoid collisions with your neighbors.

When implementing swarm behavior among motor vehicles, such an arrangement would obviously not work as motor vehicles are unable to react with the same instincts as animals. Therefore, to implement swarming behavior as between motor vehicles is necessary that the vehicles be in communication with each other.

As previously stated it is well known that vehicles may communicate via signal transmitted from one vehicle to the other while in motion and in addition may derive information from off-road sources such as GPS satellites or informational beacons located along the side of the road which may transmit information, etc.

In the preferred embodiment of this invention, groups of vehicles will form ad hoc networks based upon their proximity to each other and may exchange information to control:
i. the speed of the group as a whole;
ii. the speed and direction of individual members of the group which may be necessary to avoid collisions with nearest neighbors;
iii. the coordinated movement of the group to avoid obstacles (i.e., complex maneuvers); and
iv. decisions regarding when various vehicles or groups of vehicles join the group or break away from the group.

Such ad hoc networks may be mesh networks or may be networks in which each vehicle can communicate with every other vehicle in the group. Due to proximity requirements in the preferred embodiment a mesh network is formed in which information can propagate from one vehicle to the next in a very timely manner and wherein the vehicles can communicate to form a consensus as to the speed of the group as a whole and the spacing and relative positions of members of the group.

In addition, additional information may be derived from, for example, GPS navigation systems, map databases and off-road informational beacons. In addition, vehicles will likely be required to be equipped with sensors for sensing obstacles. Such sensing features are well known in the art, however their use as inputs to an algorithm which determines the speed of the group as a whole is not known.

To achieve full functionality as envisioned herein, vehicles must be equipped with, at a minimum, the following features:
i. hardware required to be able to communicate relevant information between vehicles;
ii. hardware required to sense other vehicles;
iii. common software to form a consensus regarding speed and complex maneuvers or to react to outside commands;
iv. the ability to control speed under software control;
v. the ability to control braking under software control; and
vi. the ability to control the directional heading of the vehicle under software control.

Various scenarios under which all or a portion of the functionality described can be implemented is discussed below.

### DESCRIPTION OF THE DRAWINGS

FIG. 1 is a block diagram of a vehicle equipped with hardware necessary to be swarm-enabled.

FIG. 2 is a block diagram of the control agent of FIG. 1

FIG. 3 is a block diagram of the software modules running on the control agent.

FIG. 4 is a flow chart showing a high level functional flow of the control agent

FIG. 5 of the flow chart showing the control agent thread used to handle communications received from other vehicles in the swarm.

FIG. 6 is a flow chart showing control agent thread use to handle inputs from various hardware sensors and other sources installed with the system.

FIG. 7 shows examples of swarms. FIG. 7(a) shows the simplest possible swarm while FIG. 7(b) shows a more complex swarm.

FIGS. 8(a-d) show a complex passing maneuver performed by a swarm in a highway situation.

FIGS. 9(a-b) shows a swarm adding a new member.

FIGS. 10(a-e) show a second complex maneuver being performed by a swarm.

### DETAILED DESCRIPTION OF THE INVENTION

The present invention is applicable to motor vehicles of all types, including those currently known and those developed later. Included would be both ground vehicles, sea vehicles, including boats and submarines, as well as aircraft and spacecraft. The invention allows for groups of vehicles to act in unison with respect to both speed and the performing of maneuvers, both simple and complex. Note that all implementation details of the invention provided here are provided as exemplary embodiments of the invention, and the invention is not meant to be limited thereby. It is expected that by the time the invention is actually implemented, new hardware of various types, for example new types of sensors, will have been developed that can be used in the context of the present application.

In addition, the invention is explained in terms of cars on a highway, however, as previously stated, the same principles apply to swarms of vehicles in urban situations, and to swarms of vehicles not restricted to two-dimensional, ground only operations.

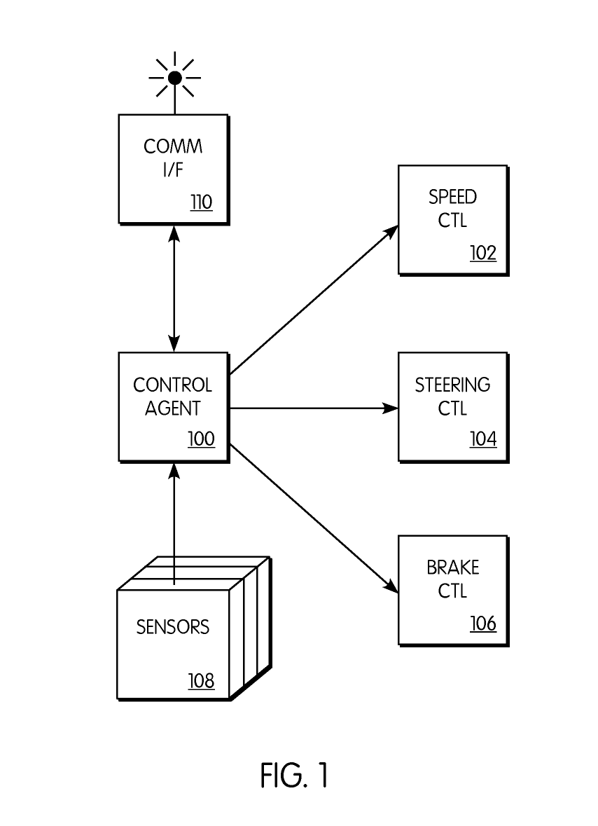

FIG. 1 is a block diagram showing the hardware configuration of a typical vehicle outfitted to utilize the swarm technology. Such vehicles will be equipped with a software/hardware control agent 100. The control agent may be implemented as software running on a processor of a type well known in the art. Alternatively, the functionality may be implemented as a hard coded module. Interfacing with the control agent is communications interface 110. Communications interface 110 enables communications with other vehicles in the swarm and with outside sources of information. Communications interface 110 may be, for example, a Wi-Fi or Bluetooth interface, or maybe a hardware and/or software protocol not yet developed. In the preferred embodiment, it is expected that communication interface 110 will allow communications with other vehicles over a network that has been developed specifically for the present application, which will provide high power, highly reliable, instantaneous communication between vehicles in the swarm, communicating over reserved frequencies, and utilizing encrypted messaging.

In an alternate, simpler embodiment, likely to be used in earlier implementations of the invention, it may be sufficient for vehicles to merely broadcast their operational parameters, and to have other vehicles read the broadcasts and conform their operational parameters to those of other vehicles, without forming a formal network.

Communications interface 110 may also communicate with outside information sources. For example, it is contemplated that in the future, information beacons may be placed periodically along roadways to provide traffic information, speed limits, roadway configurations and information regarding obstructions such as accidents and/or construction, to be used by control agent 100 to plan for changes in speed and for performing complex swarm maneuvers to avoid the obstructions or to conform to changes in roadway configurations.

At a very minimum, vehicles utilizing the simplest embodiment of this invention will need to be equipped with a speed control 102, which is capable of controlling the acceleration of the vehicle. The speed control 102 may initially be of a type similar to the cruise control feature of present day vehicles. For more complex operations, it will be necessary for vehicles to be equipped with steering control 104 and braking control 106. Steering control 104 will be able to control the direction of the vehicle, most likely through a mechanical linkage to the steering apparatus of the vehicle, and, in vehicles not restricted to ground only operations, may also control movement about the pitch, yaw and roll axes. Brake control 106 controls application of the brakes of the vehicle, if so equipped.

Swarm-enabled vehicles are preferably equipped with one or more sensors. In particular, it is desirable that one or more sensors be oriented forward of the vehicle, such as to detect obstructions in the roadway and to assist in the determination of the headway between vehicles. However, sensors may also sense other vehicles in the swarm and may be positioned on all sides of the vehicle. Sensors may include, for example, RADAR, SONAR, LIDAR, infrared and may include cameras equipped with object recognition software capable of identifying objects from a moving video image, such as a road sign, a traffic light, animals, people, or other vehicles. As previously stated, it is expected that swarm-enabled vehicles may utilize types of sensors not yet available, to be later developed. Vehicles may also be equipped with an inertial navigation system or spatial orientation systems using, for example, gyroscopes.

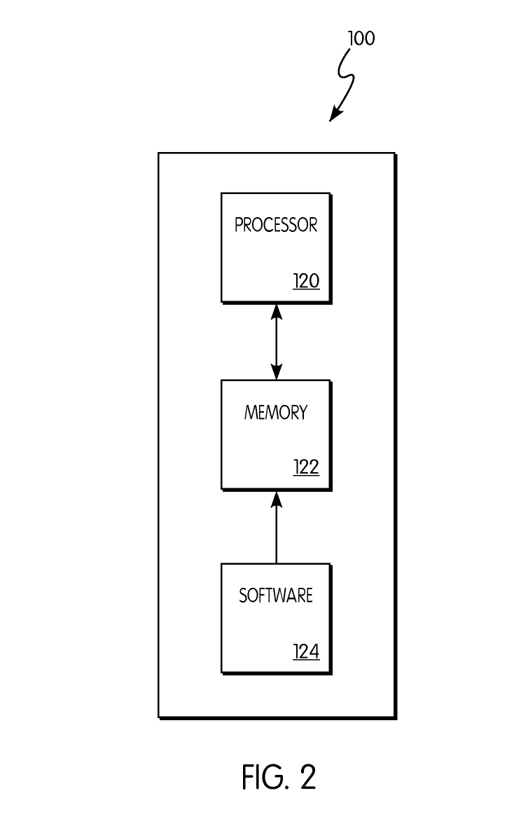

FIG. 2 is a block diagram of the control agent. As previously stated, control agent 100 may consist of software running on a processor of a type well known in the art or may be some other implementation. Control agent 100 will be equipped with memory, both permanent and random access type, for the storage of software and variables required during the operation of the vehicle as part of a swarm.

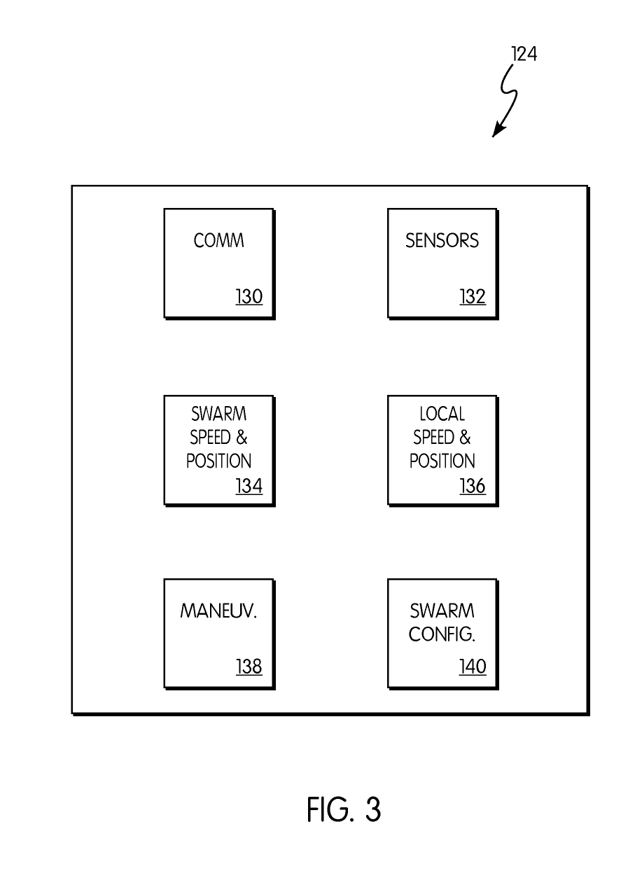

FIG. 3 is a block diagram of the software modules 124 of control agent 100. It should be recognized that the embodiment shown for the software is exemplary in nature only and that many implementations of the software with different logical configurations is possible. In the preferred embodiment, software 124 will consist of communications interface 130, which handles communications received over hardware communications interface 110 from other vehicles in the swarm; component 132 will handle input from all sensors, both internal and external; component 134 will handle changes in the global speed/positioning of the swarm; and component 136 will handle the local speed and positioning of individual vehicles, which will be responsible primarily for having a vehicle maintain its speed and distance with respect to its nearest neighbors in the swarm. Component 138 will allow the execution of movements of individual vehicles that are a part of complex maneuvers being performed by the swarm as a whole, and component 140 will handle changes to the configuration of the swarm due to the addition or deletion of members and the changing of the positions of the vehicles due to the execution of complex swarm maneuvers.

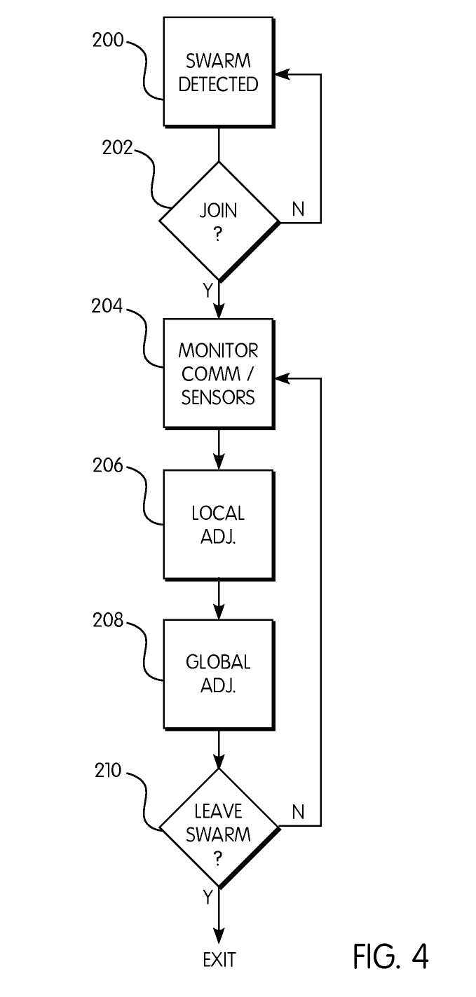

FIG. 4 is a flowchart of the high level flow of control and software component 124. In block 200, an individual vehicle which is not currently part of a swarm has detected the presence of a swarm, and in block 202 the vehicle decides whether or not to join the swarm. In various implementations, this decision may be made automatically, via an algorithm which may take in to account various parameters, for example, the destination of the vehicle, the route of the vehicle, the physical capabilities of the vehicle, etc, or the operator of the vehicle may simply be prompted for permission to join the swarm.

Swarms of vehicles may have minimum hardware and software requirements of vehicles before they will be allowed to join. For example, certain swarms may require vehicles be capable of performing automatic complex maneuvers by being equipped with steering control 104 and braking control 106, or may require that a vehicle be capable of a certain speed or have swarm software of a certain version.

In the event that a vehicle decides not to join the swarm, control is returned to block 200, where the vehicle continues to monitor for other swarms. If the vehicle decides to join the swarm in box 204, the vehicle monitors the communications interface 100 to receive global commands from the swarm and to transmit messages to the swarm and in addition, monitors on-board sensors which will be used typically to provide the capability of maintaining speed and distance with respect to nearest neighbors. In box 206 the vehicle is performing micro-maneuvers which will allow it to maintain the speed and spacing with respect to nearest neighbors. In box 208, the vehicle responds to global commands from the swarm as a whole or to commands to the swarm from an outside source. In box 210 the vehicle decides to leave the swarm, for example, at the command of the occupant of the vehicle or because the vehicle's pre-programmed route takes it away from the main body of the swarm.

Thus, the vehicle will be required to respond to both global and local commands. Global commands, in this context, are commands from or for the swarm as a whole which may require individualized maneuvers from individual members of the swarm to accomplish the overall goal of the swarm, for example, speed changes, lane changes, etc. Local commands likely originate with the vehicle and are commands which are required to maintain the vehicle's position within the swarm. Responses to local commands will likely consist of micro-maneuvers which are required to maintain the spacing between neighboring vehicles in the swarm.

It is contemplated that individual vehicles in the swarm will be able to respond to macro-maneuvers, that is, maneuvers required by commands decided on by the swarm as a whole, i.e., global command. For example, the movement of the swarm as a whole to avoid obstructions in the road or to adjust the speed of the swarm up or down, depending on local conditions. In addition, it will also be necessary for each individual vehicle will perform micro-maneuvers, which will enable it to maintain proper spacing between its nearest neighbors in the swarm, i.e., local commands. It is contemplated that each vehicle in the swarm will have an internal map of the swarm containing the positions and speeds of all vehicles in the swarm.

Preferably, the swarm will be logically constructed through the formation of an ad hoc network between the vehicles in the swarm. In the preferred embodiment, the ad hoc network will be a mesh type network wherein vehicles do not need to communicate with every other vehicle in the swarm but need only communicate with its nearest neighbors, although other types of network topologies may be used. Information regarding changes in the position/speed of individual members of the swarm, as well as global commands from the swarm, will be communicated from one node in the ad hoc mesh network to every other node in the ad hoc mesh network, and, as such each vehicle's internal map of the swarm is kept constantly updated, as is the compliance of the vehicle to swarm conditions.

Certain parameters of the swarm will be global. These may include, for example, the overall speed of the swarm as a whole, the configuration of the individual vehicles in the swarm and the state of the swarm as it performs complex maneuvers to avoid obstructions. The overall speed of the swarm may be set in accordance with various algorithms, for example, algorithms could be as simple as having the swarm maintain the current speed limit of the road, having the swarm maintain the speed limit of the road plus or minus a variance, or having the swarm set its speed in accordance with current road conditions (i.e., heavy traffic, light traffic, raining, clear, etc.). Preferably, the swarm as a whole will be able to receive information regarding down-road conditions such as to adjust its speed accordingly. It is contemplated that the swarm, under software control, may safely travel in excess of the speed limit imposed on individual vehicles.

The configuration of the swarm as a whole is also dependent upon various parameters including, for example, urban/highway situations, three lane v. two lane v. one lane roads, etc.

Decisions regarding the overall behavior of the swarm may be made, for example, by the lead cars in the swarm, as these vehicles will have knowledge regarding any potential obstructions in the road ahead, or may be made by the swarm as a whole, with each node (vehicle) in the swarm acting together to form a logical computing engine which will set swarm parameters by consensus and/or by some other algorithm which takes into account information available to the swarm. Additionally, it is contemplated that the swarm will be able to accept commands from an outside source, for example, from a central traffic planning authority which is able to coordinate traffic flow to optimize safety and efficiency.

Preferably, all vehicles in the swarm will have access to the same in formation as all other vehicles in the swarm. For example, if the lead vehicle in the swarm detects an obstruction in the road, all vehicles in the swarm will be made aware of the obstruction and the swarm as a whole will be able to take action to avoid the obstruction.

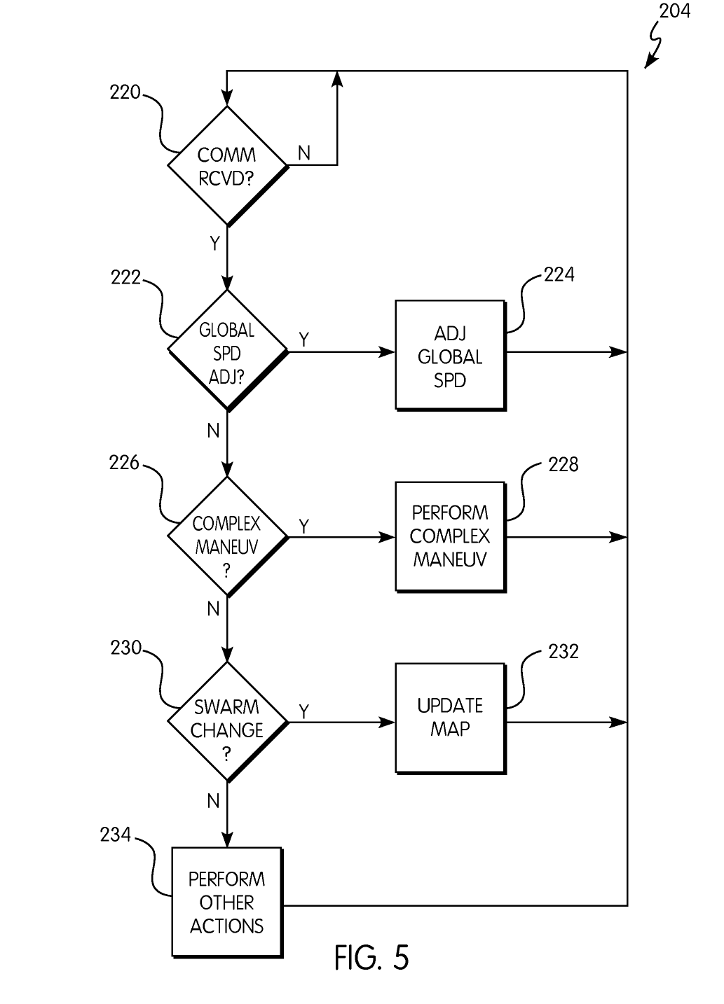

FIG. 5 shows the handling of commands received from the swarm as a whole. When utilized here the term “swarm as a whole” refers either to a swarm having assigned leaders to make decisions for the swarm or, as previously mentioned, the swarm as a whole making decisions regarding swarm configuration as a global entity or receiving commands from an outside source. In box 220, communications interface 110 is monitored for global swarm communications. If none are received, the control stays in box 220 to perform a further monitoring function. If a command is received, control proceeds to box 222 and beyond where the type of communication is determined. For example, in box 222 the control agent 100 determines if a global speed adjustment is being requested. If so, the vehicle adjusts is global speed in box 224 taking into account micro adjustments in the speed required to maintain spacing from other vehicles in the swarm. In box 226, it is determined if the swarm has decided to perform a complex maneuver. A complex maneuver would be, for example, passing a non-swarm vehicle on a highway, adjusting the configuration of the swarm to take into account changing lane conditions, for example, going from a three lane highway to a two lane highway, configuring itself for passage through construction zones, etc.

If a complex maneuver command has been received, then each individual vehicle will perform the action required on its own part to allow the swarm to perform the complex maneuver. This may require, for example, changing speed, changing the headway between vehicles to allow for the insertion of other vehicles, changing lanes, etc. Complex maneuvers will be discussed in more detail later. In box 230 it's determined if the swarm is changing its configuration, for example, adding vehicles, deleting vehicles, splitting the swarm into two swarms, reconfiguring due to a change in the road configuration, etc. If it is determined that a swarm configuration change command is being received, then the individual vehicles will update their local maps to take into account the change in the configuration of the swarm and may execute maneuvers to conform to the new configuration. In box 234 other global swarm commands of a type not yet contemplated may be received and acted upon with each individual vehicle in the swarm taking the required actions to allow the swarm to perform the global command. After each action, control returns to box 220 where each vehicle listens for further commands from the swarm.

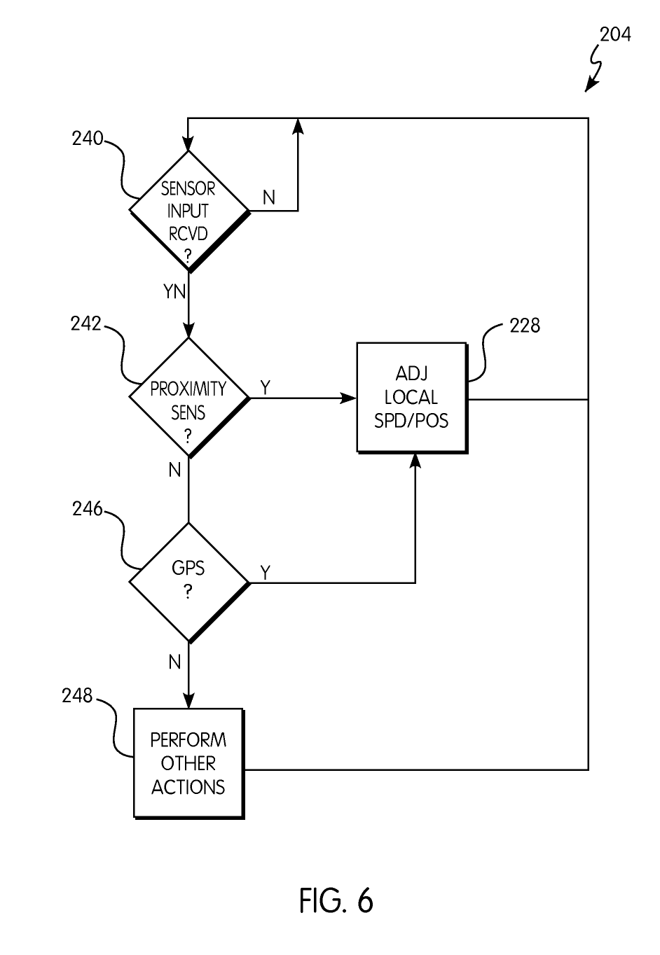

FIG. 6 shows a thread which is part of software 204 which performs micro-maneuvers based upon the reception of inputs from sensors. In box 204 it's determined if a sensor input has been received. For example, the vehicle senses that it is getting too close to the vehicle in front of it in the swarm and therefore must reduce its speed by using a micro adjustment to maintain spacing. If no sensor inputs are received, control stays in box 240 to further monitor the sensors. In box 242 the software determines if an input from a proximity sensor has been activated. A proximity sensor may gauge the distance between a vehicle and its nearest neighbors in the swarm, for example, cars ahead and behind in the same lane and cars to the left or right of the vehicle, or may be used to detect an obstruction in the road, for vehicles at the head of the swarm. Sensors may also include, for example, cameras capable of reading road signs, cameras capable of reading the lane dividing lines on a highway, etc. all of which serve as input to the control agent 100 to allow it to make micro-maneuvers to stay in lane and to maintain proximity from its nearest neighbors. In box 246 information may be obtained from a GPS device to update the vehicle, and the swarm, as to its current location. In box 248, other swarm communications not currently contemplated, but still part of the invention, are handled.

It is contemplated that the swarm may be able to receive information from outside sources, including roadside beacons which transmit information regarding the current speed limit or changes in the speed limit, beacons that broadcast mile marker information, beacons that transit changes in the road configuration, for example, three lanes merging into two, beacons that transmit information regarding traffic conditions, etc. All such information will allow the swarm to plan for self-configuration to accommodate the changing conditions, in advance. Some such information may also be derived from other means, for example, from road information databases using GPS positioning or from information broadcast over a radio frequency, although beacons will provide the advantage of providing information having positional relevance. If such beacons someday become widely available, they may be read using a “beacon sensor” in the thread of FIG. 6, with information derived from such beacons considered as “input” from a sensor similar to a reading from a proximity sensor.

In early embodiments of the invention, it is contemplated that swarm-enabled vehicles may be equipped with a speed control but may not be equipped with controls for braking and/or directional control and, as such, early embodiments of the invention may be simple speed matching implementations wherein vehicles in the swarm match their speeds to other vehicles in the swarm. This can be accomplished using the simpler embodiment where the operational parameters of a vehicle are merely broadcast, without the formation of a formal logical network. In such cases, the overall speed of the swarm may be determined by the lead vehicle, either automatically or by the operator of the vehicle, or, in more complicated embodiments, the swarm as a whole may decide, by whatever algorithm, to increase or decrease the speed of the swarm. In such cases, input will still obviously be required from an operator of the vehicle to maintain the heading of the vehicle and to maintain proximity from other vehicles.

The simplest possible swarm would be a single swarm-enabled vehicle which, while in communication with or not acting in concert with other members of the swarm, will still be able to exhibit autonomous behavior by reacting to sensor inputs and outside sources of information. In addition, the control agent 100 of a single-vehicle swarm still acts as a logic engine to determine swarm parameters. In addition, it is contemplated that such vehicles will also be able to receive commands from an outside source and react thereto.

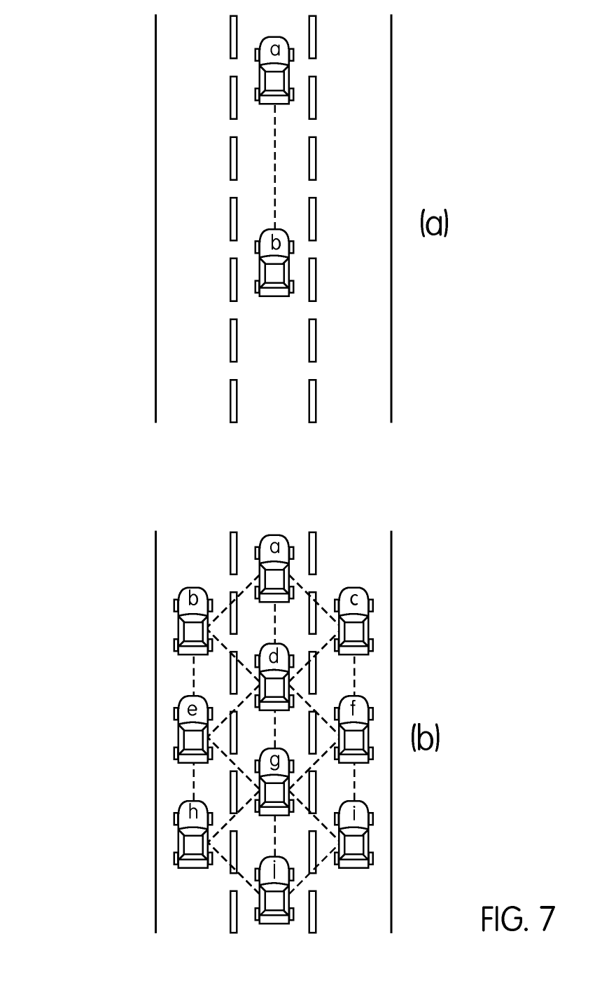

The simplest multi-vehicle swarm is shown in FIG. 7(a), consisting of two vehicles in communication with each other, or, in a simpler embodiment, having one vehicle read the broadcast operational parameters of the other vehicle. To initially form the swarm, each vehicle may broadcast its capabilities. For example, broadcasting a message that states “I am swarm enabled”, including information regarding the level to which the vehicle is automated to be able to perform various swarm functions. When vehicle B, for example, discovers that vehicle A is swarm enabled it may request to join with vehicle A to form a swarm consisting of vehicles A and B, as show in FIG. 7(a), or it may simply decide to follow the movements of vehicle A, without vehicle A being aware that vehicle B is doing so.

FIG. 7(b) shows a much more complex swarm consisting of vehicles A-J, all in communication with each other. The connections between vehicles show the formation of the ad hoc network having a mesh topology. Even with very simple capabilities, for example, in early implementations, vehicles having only speed control, still allows a great advantage in accident avoidance. If vehicles A, B or C detect an obstruction in the road requiring an emergency stop, for example, an animal running into the road or a pedestrian wandering onto the road, the vehicle is able to broadcast to the whole swarm that an emergency stop is required and the swarm as a whole is able to perform the emergency stop as a unit, thereby avoiding rear end collisions from vehicles in the rearward portion of the swarm. This type of control may also have an advantage in urban situations, for example, with swarm vehicles stopped at a read light. As the light turns green, all vehicles in the swarm will be able to start at the same time, thereby avoiding the propagation delay in starting from one vehicle to the next.

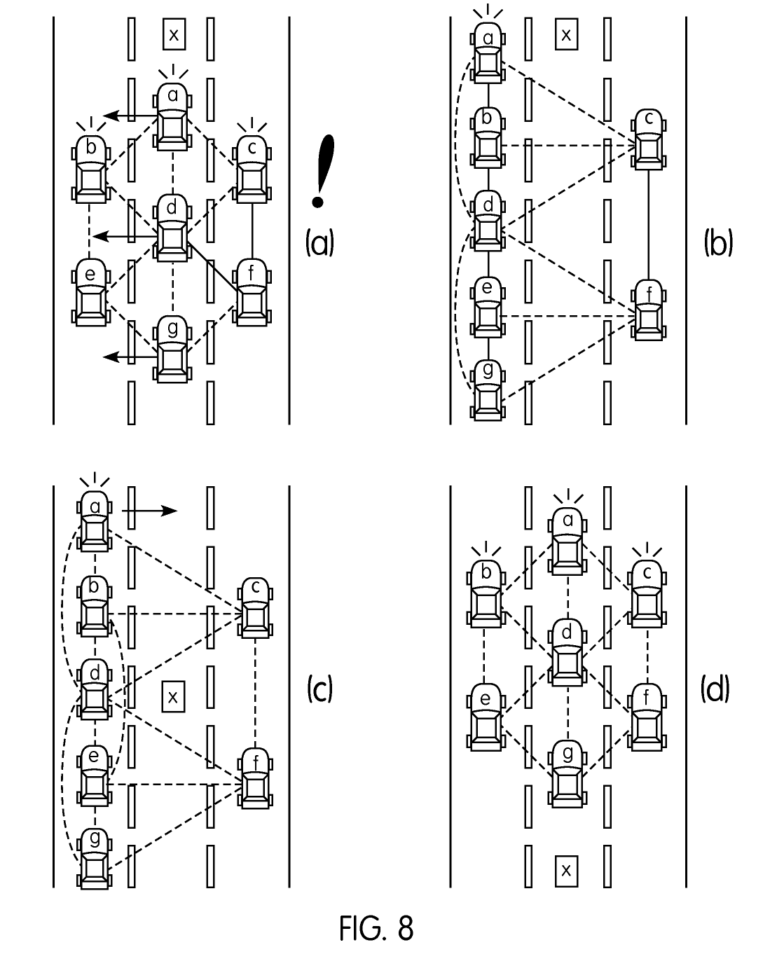

FIGS. 8(a-d) show an example of a swarm performing a complex maneuver. It should be noted that to perform a complex maneuver, such as that shown in FIG. 8, it is preferred that the vehicles be equipped with the capability of automatically controlling the heading as well as speed of the vehicle. Alternatively, for vehicles equipped with only speed control, it may be sufficient for the vehicle to provide feedback to the driver. For example, the vehicle tells the driver it is now time to switch from the center lane to the left lane.

In FIG. 8(a), vehicle A in the swarm detects a non-swarm vehicle X in the center lane, for example, a truck. To allow the swarm to pass vehicle X it is necessary to move vehicles A, D and G out of the center lane and into either the left lane or the right lane or a combination of both. In this case, the swarm decides to send vehicles A, D and G to the left lane. To perform this maneuver it may be necessary for vehicles B and E to adjust their speed and position via micro maneuvers to increase their headway to allow vehicles A, D and G to move into the left lane. In FIG. 8 (b), the swarm has reconfigured itself such as to allow passing of vehicle X by moving vehicles A, D and G to the left lane in between vehicles B and E. FIG. 8(c) shows the swarm passing vehicle X and in FIG. 8(d) the swarm has reconfigured itself to its preferred configuration. Note that it is not necessary for the swarm to be in a configuration such as shown in FIG. 8(a) or 8(d). The optimal configuration for the swarm may be determined as vehicles join or are deleted from the swarm and the intelligence to determine the optimal configuration is not necessarily part of this invention.

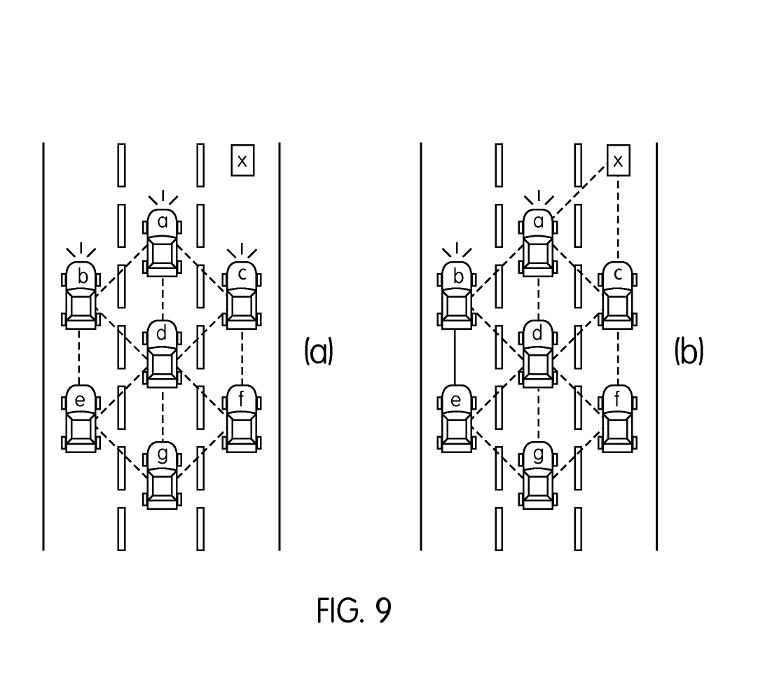

FIGS. 9(a-b) show a vehicle joining the swarm. In FIG. 8(a), vehicle C detects that it is approaching a vehicle that is not part of the swarm. If vehicle X is swarm-enabled it may be invited to join the swarm and the swarm may reconfigure itself as shown in FIG. 9(b) to accommodate the addition of vehicle X. In the event that vehicle X is not a swarm-enable vehicle, the swarm will need to reconfigure itself as shown in FIG. 8 to avoid the obstructing vehicle X.

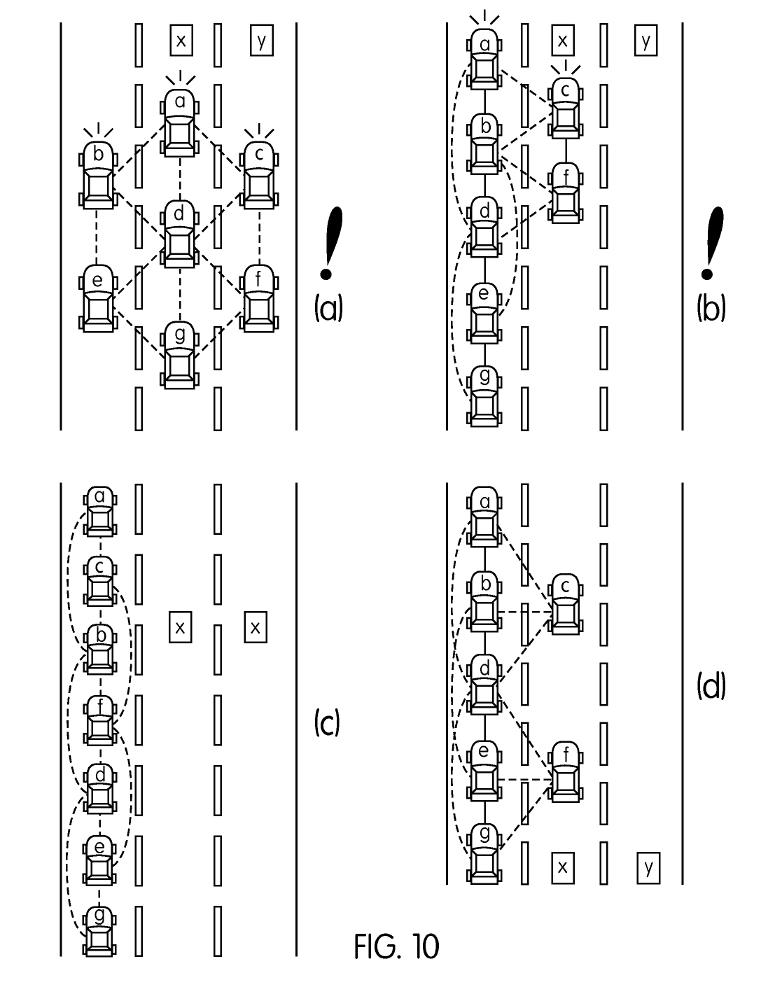

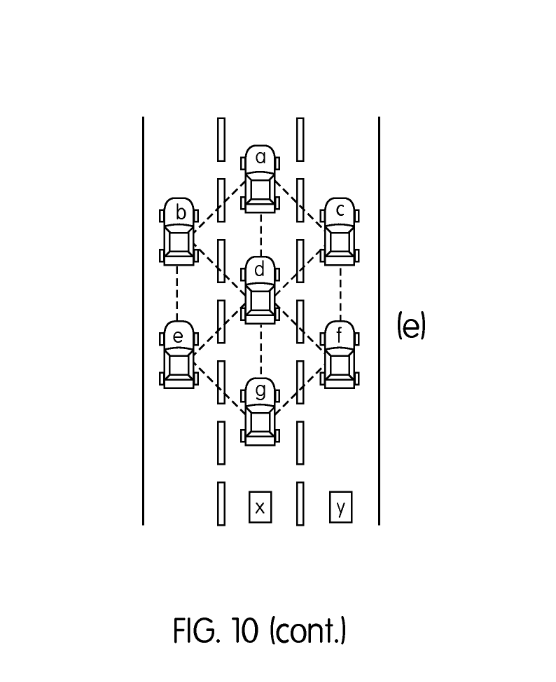

FIGS. 10(a-e) show another complex maneuver in which vehicles X and Y are being approached by the swarm and wherein the swarm must configure itself to avoid vehicles X and Y by moving all vehicles in the swarm to the left lane. In FIG. 10(b), we see that vehicles A, D and G have moved to the left lane with vehicles B and E. In FIG. 10(c), vehicles C and F have also moved to the left lane. To perform this maneuver it may be necessary for individual vehicles in the swarm to perform micro maneuvers to increase the headway between vehicles and it may also be necessary to adjust the speed of the vehicles to perform the micro maneuvers. In FIG. 10(c) we see that all vehicles are now in the left lane and passing vehicles X and Y and in FIGS. 10(d) and 10(e), the swarm reconfigures itself to its optimal configuration.

When vehicles wish to depart the swarm, for example, a car in the middle of the swarm may have to leave the swarm to exit a highway, the swarm must reconfigure itself to allow the vehicle leaving the swarm to migrate to the right lane for exiting. Preferably, vehicles will know well in advance, due to routes programmed into a GPS type device, of the preferred route of each individual vehicle to allow maneuvering of vehicles leaving the swarm in advance of the time necessary to do so.

In the ultimate embodiment of the invention, the vehicle's operation while a member of the swarm will be completely autonomous. That is, requiring no intervention from the driver. Feedback may be provided to the driver regarding maneuvers that are to be performed by the vehicle such as not to alarm the occupants when the vehicle changes its speed and/or configuration to accommodate the complex maneuvers being performed by the swarm. In addition, it may be necessary for the vehicle to inform the driver when he must take over manual control of the vehicle. For example, when the vehicle exits the swarm and is deposited on the exit ramp of a highway.

In further embodiments of the invention, roadways may be equipped with informational beacons showing positioning and/or conditions of the road. In addition, it is contemplated that traffic signals would broadcast their current state such as to inform oncoming swarms that for example, a light is red and the swarm must stop. Alternatively, the swarm may sense the condition of lights via image recognition from forward mounted cameras.

As previously stated, vehicles may operate autonomously as single vehicle swarms. For example, a swarm-enabled vehicle operating autonomously without being in contact with other vehicles that are swarm enabled may perform the same autonomous functions on an individual basis as if the vehicle were part of a swarm containing multiple vehicles.

The invention has been described in terms of various exemplary embodiments that describe the overall behavior of swarms of vehicles. The implementation of algorithms required to perform these vehicle are not to be considered part of the invention, at it is contemplated that such algorithms will be necessarily created to be in compliance with any regulations and/or to optimize safety of the occupants of the vehicles. Therefore the invention is not meant to be limited by specific implementations of the algorithms.

I claim:

1. A system for autonomously controlling a vehicle comprising:
a communications interface for exchanging telemetry with a group of one or more other vehicles;
a control agent; and
a speed controller for controlling the speed of said vehicle, said speed controller being controlled by said control agent;
wherein said control agent receives information via said communications interface regarding the speed of said group of one or more other vehicles and causes said speed controller to set the speed of said vehicle to match the speed of said group of one or more other vehicles.

2. The system of claim 1 said vehicle becomes a member of said group of one or more vehicles, wherein membership in said group is defined by receiving telemetry from one or more other vehicles in said group and acting upon said telemetry.

3. The system of claim 2 wherein the speed of said group of vehicles is set by one member vehicle of said group.

4. The system of claim 2 wherein the speed of said group of vehicles is set by a consensus of the control agents associated with each of said vehicles in said group.

5. The system of claim 2 wherein said control agent received telemetry regarding changes in et speed of said group of vehicles and adjusts its own speed in accordance therewith.

6. The system of claim 2 further comprising:
one or more sensors on said vehicle, said sensors providing information to said control agent regarding the proximity of other vehicles in said group of vehicles;
wherein said control agent varies the speed of said vehicle to maintain a minimum spacing between said vehicle and other vehicles in said group.

7. The system of claim 2 further comprising:
a braking controller for controlling a brake system in said vehicle, said braking controller being controlled by said control agent.

8. The system of claim 2 wherein said vehicle received telemetry regarding other member of said group.

9. The system of claim 9 wherein said telemetry includes vehicle identification information, vehicle location information and operating parameters of said vehicle.

10. The system of claim 2 further comprising:
a directional controller, for controlling the orientation of said vehicle, said directional controller being controlled by said control agent.

11. The system of claim 10 wherein said group of vehicles can coordinate the movement of individual members of said group such that complex maneuvers of the group as a whole may be carried out.

12. The system of claim 11 wherein said complex maneuvers include avoidance of obstacles detected by sensors on one or more members of said group.

13. The system of claim 10 wherein each vehicle in said group responds to global commands from the group for changes in orientation, configuration and speed of the group as a whole and further wherein each vehicle in said group makes local adjustments independent of said group to maintain a minimum spacing between said vehicle and other vehicles in said group.

14. The system of claim 1 wherein said control agent receives supplementary information from one or more sources outside of said group of vehicles.

15. The system of claim 14 wherein said supplementary information includes one or more of location information, road condition information, traffic signal information, weather information and road configuration information.

16. The system of claim 13 wherein said group can plan future maneuvers based on said one or more sources of supplementary information.

17. The system of claim 2 wherein said vehicle signals to an operator when it is not longer following control information from said group, indicating that that manual operation of the vehicle is necessary.

18. A system for autonomously controlling a vehicle comprising:
a communications interface for exchanging telemetry with a group of one or more other vehicles;
a control agent; and
one or more controllers for controlling various operating parameters of said vehicle under the control of said control agent;
wherein said control agent receives information via said communications interface regarding the various operating parameters said group of one or more other vehicles and uses said received information to make decisions regarding the control of said operating parameters of said vehicle.

19. The system of claim 18 wherein said vehicle is considered a member of said group of vehicles when said control agent is receiving telemetry from one or more member of said group and using said received telemetry to control said one or more operating parameters of said vehicle.

20. A system for coordinating the operating parameters of a group of vehicles as a whole, wherein each of said vehicles is equipped with:
a communications interface for exchanging telemetry with a group of one or more other vehicles or with an outside source;
a control agent; and
one or more controllers for controlling various operating parameters of said vehicle under the control of said control agent;
wherein said control agent controls said various operating parameters of said vehicle in response to said telemetry received from other members of said group, from said group as a whole or from said outside source.
